(19) United States
(12) Patent Application Publication
(10) Pub. No.: US 2015/0215661 A1
(43) Pub. Date: Jul. 30, 2015

(54) System And Method For Distributing Live Broadcast Content

(71) Applicant: ZTE CORPORATION, Shenzhen City Guangdong Province (CN)

(72) Inventors: Fang Wang, Shenzhen City (CN); Deguang Huang, Shenzhen City (CN)

(21) Appl. No.: 14/423,014

(22) PCT Filed: Jul. 26, 2013
(86) PCT No.: PCT/CN2013/080191

§ 371 Date: Feb. 20, 2015

(30) Foreign Application Priority Data
Aug. 24, 2012 (CN) 201210305430.5

(51) Int. Cl. H04N 21/262; H04N 21/845; H04N 21/858; H04N 21/482; H04N 21/647; H04N 21/643; H04N 21/6437; H04N 21/237; H04N 21/254; H04N 21/2187; H04N 21/61

(52) U.S. Cl. CPC H04N 21/26258; H04N 21/2187; H04N 21/8456; H04N 21/858; H04N 21/4825; H04N 21/6125; H04N 21/64322; H04N 21/6437; H04N 21/643; H04N 21/237; H04N 21/254; H04N 21/647

(57) ABSTRACT

Disclosed are a system and a method for distributing live broadcast content, wherein the method includes: a film library server converting a signaling sent by a live broadcast encoder for uploading/deleting/updating a file into live broadcast streaming data packets in a predetermined format; actively pushing or passively sending the converted live broadcast streaming data packets to an intermediate node server, or the intermediate node server receiving or actively pulling the live broadcast streaming data packets from the film library server until the live broadcast streaming data are actively pushed or passively sent to an edge node server; and the edge node server which receives the live broadcast streaming data packets recovering the live broadcast streaming data packets to the signaling previously sent by the live broadcast encoder, and generating/deleting/updating a corresponding media segment file and playlist description file according to an instruction of the signaling.

### CROSS-REFERENCE TO RELATED APPLICATION(S)

This application is the U.S. National Phase application of PCT application number PCT/CN2013/080191 having a PCT filing date of Jul. 26, 2013, which claims priority of Chinese patent application 201210305430.5 filed on Aug. 24, 2012, the disclosures of which are hereby incorporated by reference.

### TECHNICAL FIELD

The present invention relates to the field of multimedia technology, and more particularly, to a system and method for distributing live broadcast content.

### BACKGROUND OF THE INVENTION

The Internet TV service is a quasi-real-time streaming media service based on the HTTP protocol. The service segments the program content into a lot of small segments, such as a segment of 10 seconds or 2 seconds. Then a playlist description file is used to gather these segments together. The playlist file describes the URLs (Uniform/Universal Resource Locators), durations, attributes (such as different bit rates) and time relationship of these segments and so on.

As shown in FIG. 1, FIG. 1 is a structural framework diagram of an existing Internet TV system achieving a live broadcast service, and the live broadcast encoder 101 uploads the media segment file and the playlist file to the film library web server 102 via the HTTP or FTP protocol and so on, or deletes or updates expired files in the web server 102. When a first user 105 requests the local edge web server 104 for the content service, if the edge web server 104 does not have the corresponding content file, a request will be initiated to the web cache server 103 at the upper level, and progressively traced to the film library 102. After the web cache server 103 receives the file content returned by the film library web server 102, the web cache server 103 forwards the file content to the edge web server while caches it in the local. Similarly, after receiving the file content returned by the web cache server 103, the edge web server 104 forwards the file content to the user terminal 105 while caches it in the local. Therefore, when the second user 106 requests for the same content service, the edge web server 104 can read the locally cached content to provide the service.

However, for the live broadcast service, since its playlist file and segment file are continuously updated and rolled back, if the content cached in the web server is read out to provide the service, it cannot guarantee that the content is up to date, leading to that the delay misalignment existing between the content viewed by the user and the live broadcast content viewed in the traditional mode further increases. Moreover, if the web server does not cache the corresponding content or the corresponding content has expired, the web server needs to real-time request the server at the upper level for the content, which increases the response delay of the user.

### SUMMARY OF THE INVENTION

In view of the abovementioned analysis, the embodiment of the present invention is to provide a system and method for distributing live broadcast content, to solve the problem that there is a relatively large delay in the live broadcast content in the existing Internet TV service.

The objective of the embodiment of the present invention is mainly achieved through the following technical scheme:

a system for distributing live broadcast content, comprising: a film library server, an intermediate node server and an edge node server, wherein

the film library server is configured to convert a signaling sent by a live broadcast encoder for uploading/deleting/updating a file into live broadcast streaming data packets in a predetermined format, and actively push or passively send the live broadcast streaming data packets to the intermediate node server;

the intermediate node server is configured to actively pull the live broadcast streaming data packets from the film library server or receive the live broadcast streaming data packets actively pushed by the film library server, and actively push or passively send the live broadcast streaming data packets to the edge node server;

the edge node server is configured to actively pull the live broadcast streaming data packets from the intermediate node server or receive the live broadcast streaming data packets actively pushed by the intermediate node server, and recover them to the signaling previously sent by the live broadcast encoder, as well as generate/delete/update a corresponding media segment file and playlist description file according to an instruction of the signaling.

The film library server comprises at least: a live broadcast encoder, a signaling conversion unit and a content distribution unit, wherein

the live broadcast encoder is configured to send a signaling for uploading/deleting/updating a file;

the signaling conversion unit is configured to: after receiving the signaling sent by the live broadcast encoder for uploading/deleting/updating a file, judge whether the signaling is complete or not, and if yes, convert the signaling into live broadcast streaming data packets in a predetermined format, and trigger the content distribution unit; if no, judge whether the length of data of the received signaling meets a predetermined threshold or not, and convert data whose length meets the predetermined threshold into live broadcast streaming data packets in the predetermined format; if the length of data of the received signaling is less than the predetermined threshold, continue to receive data of the signaling, and convert the signaling until the length meets the predetermined threshold or the signaling is complete; and perform conversion compulsorily on data which is still incomplete or whose length has not reached the predetermined threshold yet after exceeding a predetermined timeout period; and trigger a content distribution unit after conversion;

the content distribution unit is configured to actively push the live broadcast streaming data packets to the intermediate node server; or forward the live broadcast streaming data packets to the intermediate node server when there is a request from the intermediate node server.

The edge node server comprises at least: a signaling recovery unit, a cache unit and a storage device, wherein

the signaling recovery unit is configured to: after receiving the live broadcast streaming data packets, recover them to a signaling form previously sent by the live broadcast streaming server, and judge whether the recovered data packets are abnormal or not, and if yes, discard the data packets; if no, extract and send payloads therein to the cache unit;

the cache unit is configured to put together the payloads obtained through several times into a complete signaling, and trigger the storage device to generate/delete/update a corresponding media segment file and playlist description file according to an instruction of the signaling;

the storage device is configured to store the media segment file and the playlist description file.

The edge node server further comprises:

a content service unit, which is configured to: when there is a user terminal requesting for live broadcast service, read and return the corresponding media segment file and playlist description file to the user terminal according to the request.

The live broadcast streaming data packet comprise at least: a packet sequence number, a channel identifier, and status information whether a data packet is complete or not, and the signaling recovery unit is configured to: after receiving the live broadcast streaming data packets, firstly group the data packets according to the channel identifiers therein; then perform sequencing on the data packets according to the packet sequence numbers; for each data packet, judge whether the data packet is abnormal or not according to status information, if no, extract and send a payload therein to the cache unit, otherwise, discard the data packet.

The signaling sent by the live broadcast encoder is a HTTP or FTP signaling, and the predetermined format is a RTP format.

A method for distributing live broadcast content comprises:

a film library server converting a signaling sent by a live broadcast encoder for uploading/deleting/updating a file into live broadcast streaming data packets in a predetermined format;

actively pushing or passively sending the converted live broadcast streaming data packets to an intermediate node server, or, the intermediate node server receiving or actively pulling the live broadcast streaming data packets from the film library server; until the live broadcast streaming data packets are actively pushed or passively sent to an edge node server;

the edge node server which receives the live broadcast streaming data packets recovering them to the signaling previously sent by the live broadcast encoder, and generating/deleting/updating a corresponding media segment file and playlist description file according to an instruction of the signaling.

The method further comprises:

when there is a user terminal requesting for a live broadcast service, the edge node server reading and returning a corresponding media segment file and playlist description file to the user terminal according to the request.

The step of converting the signaling into a live broadcast stream in a predetermined format comprises:

after receiving the signaling sent by the live broadcast encoder for uploading/deleting/updating a file, the film library server judging whether the signaling is complete or not, if yes, converting it into live broadcast streaming data packets in the predetermined format; if no, judging whether the length of data of the received signaling meets a predetermined threshold or not, and converting data whose length meets the predetermined threshold into live broadcast streaming data packets in the predetermined format; continuing to receive data of the signaling if the length of data of the received signaling is less than the predetermined threshold, and performing conversion until its length meets the predetermined threshold or the signaling is complete.

The method further comprises:

performing conversion compulsorily on data which is still incomplete or whose length has not reached the predetermined threshold yet after exceeding a predetermined timeout period.

The live broadcast streaming data packet comprises at least: a packet sequence number, a channel identifier, and status information whether a data packet is complete or not, then the step of recovering data packets to the signaling previously sent by the live broadcast encoder comprises:

after receiving the live broadcast streaming data packets, firstly, the edge node server grouping the data packets according to the channel identifiers therein; then performing sequencing on the data packets according to the packet sequence numbers; for each data packet, judging whether the data packet is abnormal or not according to the status information, and if no, extracting and recovering payloads therein to the signaling previously sent by a live broadcast streaming server, otherwise, discarding the data packet.

The beneficial effects of the embodiment of the present invention are as follows:

in the embodiment of the present invention, the HTTP live broadcast content generated by the live broadcast encoder is timely distributed to the edge node server, to provide the HTTP live broadcast service for the user terminal in the neighborhood, thereby reducing the response delay of the user requesting service, as well as reducing the delay misalignment between the content viewed by the user and the traditional real-time live broadcast content.

### BRIEF DESCRIPTION OF THE DRAWINGS

FIG. 1 is a structural framework diagram of an Internet TV system achieving a live broadcast service in the related art;

FIG. 2 is a schematic diagram of the structure of a system embodiment in the present invention;

FIG. 3 is a schematic diagram of the structure of a preferred system embodiment in the present invention;

FIG. 4 is a schematic diagram of a specific implementation process of segmenting the HTTP signaling in accordance with an embodiment of the present invention;

FIG. 5 is a schematic diagram of a specific implementation process of recovering the RTP data packets in accordance with an embodiment of the present invention;

FIG. 6 is a schematic diagram of the process of a method embodiment in the present invention.

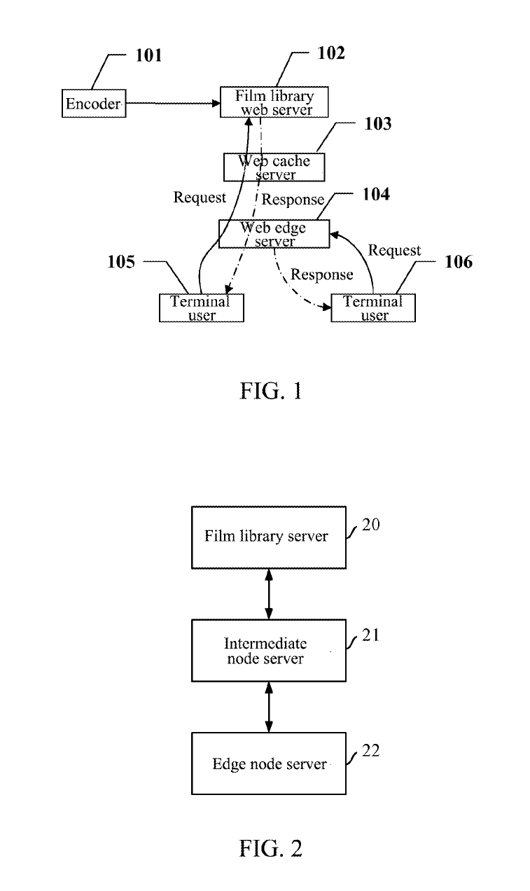

### PREFERRED EMBODIMENTS OF THE INVENTION

Hereinafter, the preferred embodiments of the present invention will be described in detail in conjunction with the accompanying drawings, wherein the accompanying drawings form a part of this application and together with the embodiments of the present invention serve to explain the principles of the embodiment of the present invention.

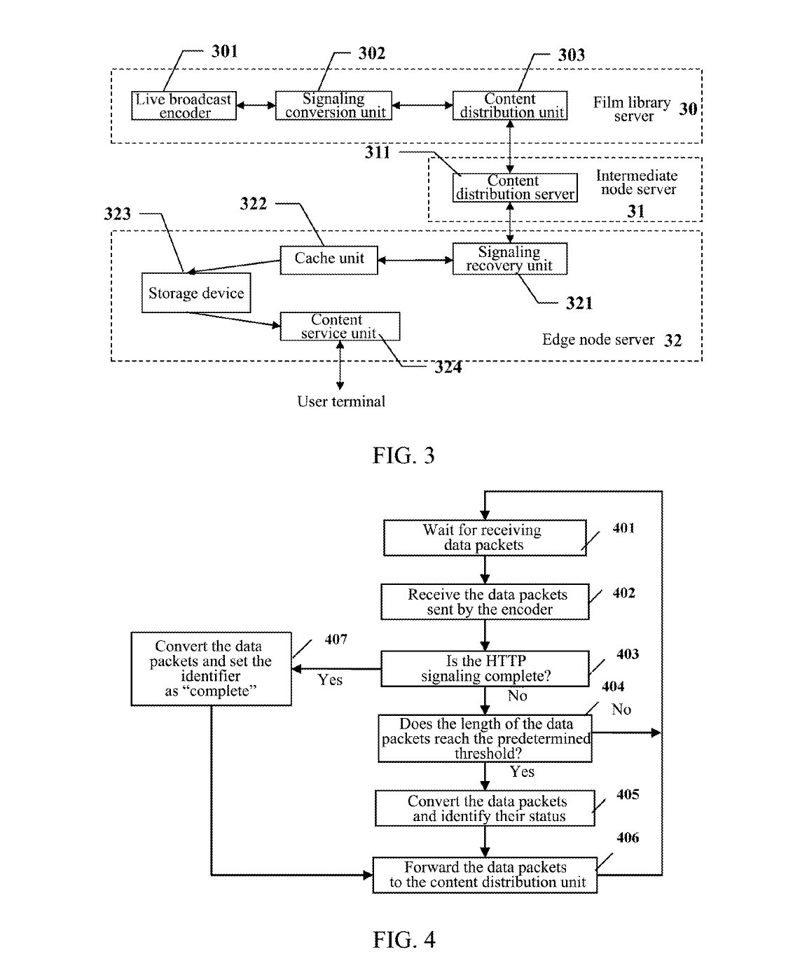

First, the system in accordance with an embodiment of the present invention will be described in detail in combination with FIG. 2 and FIG. 3.

As shown in FIG. 2, FIG. 2 is a schematic diagram of the structure of the system in accordance with an embodiment of the present invention, specifically comprising:

a film library server, an intermediate node server and an edge node server, wherein

the film library server 20 is configured to convert a signaling sent by a live broadcast encoder for uploading/deleting/updating a file into live broadcast streaming data packets in a predetermined format, and actively push the live broadcast streaming data packets to the intermediate node server 21, or send the live broadcast streaming data packets to the intermediate node server 21 when the intermediate node server 21 initiates a service request;

the intermediate node server 21 is configured to actively pull the live broadcast streaming data packets from the film library server 20 or receive the live broadcast streaming data packets actively pushed by the film library server 20, and actively push the live broadcast streaming data packets to the edge node server 22;

the edge node server 22 is configured to actively pull a plurality of live broadcast streaming data packets from the intermediate node server 21 or receive the live broadcast streaming data packets actively pushed by the intermediate node server, and recover them to the signaling previously sent by the live broadcast encoder, as well as generate/delete/update a corresponding media segment file and playlist description file according to the instruction of the signaling.

Hereinafter, the preferred system embodiment of the present invention will be further illustrated, and for ease of understanding, the description assumes that the live broadcast encoder uses the HTTP signaling, and the predetermined conversion format is the RTP format, and the payload of the RTP data packet is the segmented HTTP signaling.

The data packet in the RTP format needs to comprise the following information:

a channel identifier, since the encoder may simultaneously upload/update a media file through a plurality of HTTP/FTP channels, the channel identifier is used to identify different HTTP/FTP channels used by the encoder;

a packet sequence number, which is used to judge whether there are situations such as the packet loss or disordering and so on; data packets with different channel identifiers can use their own independent sequence number space;

status information, such as the offset position of the data packet in the original signaling packets, or the status information that the data packet belongs to the first packet, the last packet or an intermediate packet of the original signaling packets and so on;

alternatively, it may also comprise the transport information used by the original signaling, such as transport protocol (HTTP/FTP), transport port number and so on.

As shown in FIG. 3, FIG. 3 is a schematic diagram of the structure of a preferred system embodiment of the present invention, specifically comprising: the film library server 30, intermediate node server 31 and edge node server 32, wherein the film library server 30 specifically comprises: the live broadcast encoder 301, signaling conversion unit 302 and content distribution unit 303; the edge node server 32 specifically comprises: the signaling recovery unit 321, cache unit 322, storage device 323 and content service unit 324.

After generating a media segment file and a playlist description file, the live broadcast encoder 301 sends the signaling conversion unit 302 the signaling for uploading/deleting/updating a file via the PUT/DELETE/UPDATE message and so on in the HTTP format;

after receiving the HTTP signaling sent by the live broadcast encoder 301 for uploading/deleting/updating a file, the signaling conversion unit 302 returns a response message to the live broadcast encoder and repacks the HTTP signaling for uploading/deleting/updating the file, converting into data packets in the RTP format, and then it forwards the data packets to the content distribution unit 303.

It should be noted that, after receiving the HTTP signaling for uploading/deleting/updating a file from the encoder 301, the signaling conversion unit 302 segments and converts the signaling into data packets in the RTP (Real-Time Transport Protocol) format according to the predetermined threshold of length. Since a HTTP signaling may be very long, in order to ensure the timeliness of content distribution and reduce the delay, the signaling conversion unit 302 does not have to wait for receiving the complete HTTP signaling to perform the conversion, and a portion of the data can be packed and forwarded after being received, and the specific process can refer to the related description in the following FIG. 4.

Furthermore, in order to facilitate the subsequent processing of the signaling recovery unit 321, it is better not to put different HTTP signalings in one RTP data packet, in addition, the status of a RTP data packet is identified in the header of the RTP data packet, for example, it is the first packet, the last packet or complete data packet of one HTTP signaling and so on, and then the RTP data packet is submitted to the content distribution unit 303 and actively pushed to the content distribution unit of the intermediate server node through the unicast or multicast mode, or pulled by the content distribution unit of the intermediate service node, for example, a RTSP link to the content distribution unit 303 is established through the RTSP (Real Time Streaming Protocol)/RTP mode to pull the converted RTP data packets; or the converted data packets are pulled via the HTTP mode, and the RTP data packets are multiplexed into the HTTP channel for transmission.

Because the live broadcast encoder 301 may simultaneously send the HTTP signalings of a plurality of files of the same live broadcast content to the signaling conversion unit 302 through a plurality of HTTP links, the signaling conversion unit 302 needs to perform processing while conversion, so as to avoid mixing these different HTTP signalings. For example, for the abovementioned distribution via the RTP mode, and in the RTP data packets, the signaling conversion unit 302 may use different SSRCs (Synchronization Source, synchronous source field in the RTP data packet) to identify the HTTP signalings sent by the live broadcast encoder 301 through different HTTP links, and when the content distribution unit 303 distributes the converted RTP data packets, the RTP data packets with different SSRCs can be distributed by using different RTP channels or distributed by multiplexing the same RTP channel, and the receiving party, that is, the content distribution unit of the intermediate node server can performs distinguishing through the SSRC. For the abovementioned distribution via the HTTP mode, the signaling conversion unit 302 may forward the requests received through different HTTP channels to the content distribution unit 303 through different HTTP channels as well.

The content distribution unit 303 is responsible for distributing these RTP data packets in the intermediate node server, if there are several levels of intermediate nodes, continuing to distribute the data packets to the next level of intermediate node server, until to the edge node server. During the distribution, the mode in which the content distribution unit 303 actively pushes the data packets to the content distribution unit 311 of the intermediate node server 31 or the mode in which the content distribution unit 311 of the intermediate node server 31 pulls the data packets may be employed; if there are several levels of intermediate node servers, its distribution mode can also be actively pushing or the lower-level intermediate node server pulling. Similarly, the content distribution unit 303 may also use different HTTP or RTP channels to forward the data packets to the content distribution unit of the intermediate node server.

The content distribution unit 311 of the intermediate node server 31 receives the RTP data packets actively pushed by the content server 303 and actively pushes the RTP data packets to the content distribution unit of intermediate server at the lower level or the signaling recovery unit 321 of the edge node server 32, it can also actively pull the RTP data packets from the content distribution unit 303.

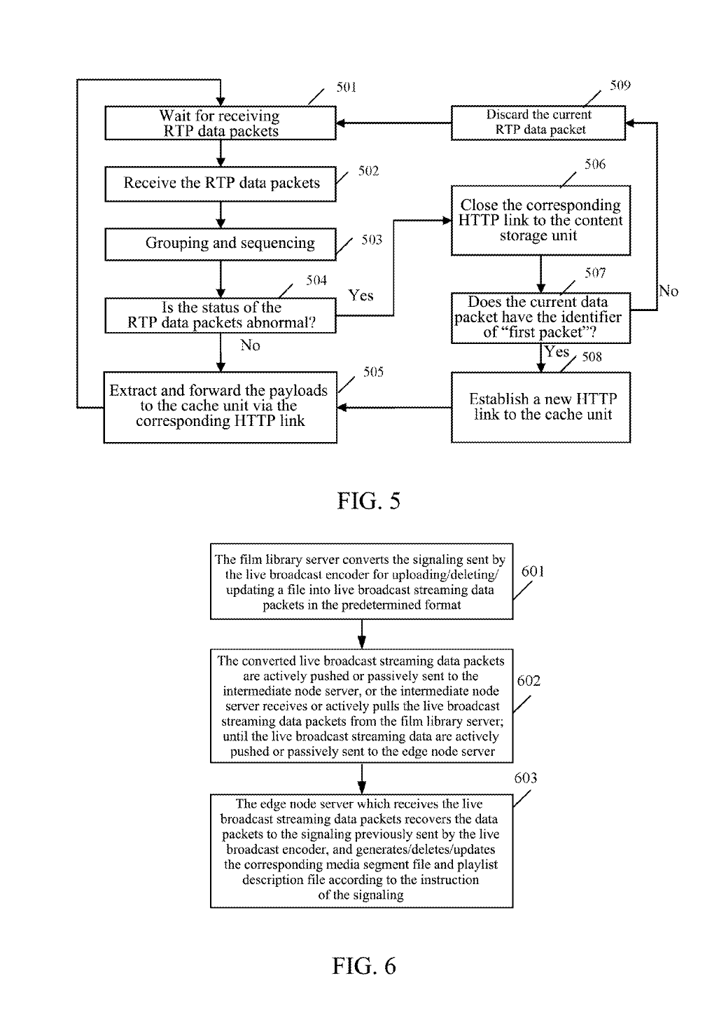

The signaling recovery unit 321 uses a method similar to the one used by the intermediate node server to receive the RTP data packets actively pushed by the content distribution unit of its intermediate node server at upper level, or obtains the RTP data packets from the content distribution unit of its intermediate node server at upper level through the pulling method, recovering the received RTP data packets to the data packets in the HTTP signaling format previously sent by the live broadcast encoder 301, and it sends the data packets to the cache unit 322. The signaling recovery unit 321 does not have to wait for receiving all the converted RTP packets of a complete HTTP signaling to perform the signaling recovery, and the specific recovery process can refer to the related description in FIG. 5.

The cache unit 322 analyzes the received HTTP signaling, and generates/updates/deletes the corresponding media segment file and the playlist description file in the storage device 323 according to the instruction of the HTTP signaling; wherein the storage device 323 may be a memory or a peripheral device such as a disk or a disk array.

The content service unit 324, when a user terminal requests the edge node server for live broadcast service, the content service unit 324 is responsible for receiving and analyzing the HTTP GET request of the user terminal, reading and returning the corresponding media segment file and the playlist description file in the storage device 323 to the user terminal.

The specific implementation process of the signaling conversion unit 302 segmenting the HTTP signaling is shown in FIG. 4, specifically comprising:

step 401: waiting for receiving data packets, sent by the live broadcast encoder, which constitute the HTTP signaling;

step 402: receiving the data packets, sent by the live broadcast encoder, which constitute the HTTP signaling;

step 403: judging whether the received data packets are a complete HTTP signaling or not, if yes, proceeding to step 407; if no, executing step 404:

step 404: judging whether the length of the received data packets is greater than the predetermined threshold (usually not more than the size of the maximum transmission unit (MTU) transmitted through the network, for example, the size can be set to 1400 bytes) or not, and if yes, executing step 405, otherwise proceeding to step 401 and continue to wait;

in step 405: converting this part of data into RTP data packets, and identify the status of the RTP data packets, such as the “the first packet”;

step 406: forwarding the RTP data packets to the content distribution unit 303 and return back to step 401;

step 407: converting the current data packet into a RTP data packet and set the status of the RTP data packet to a “complete packet”.

It should be noted that, in order to ensure the timely forwarding of data, a timeout period can also be set, and for the data that have not reached the aforementioned conversion conditions yet when exceeding the timeout period, the data are converted compulsorily.

The specific implementation process of the signaling recovery unit 321 recovering the RTP data packets is shown in FIG. 5, specifically comprising:

step 501: waiting for receiving each RTP data packet;

step 502: receiving a RTP data packet sent by the signaling forwarding unit through the content distribution unit 303 and the intermediate node server;

step 503: after receiving the RTP data packet, grouping the data packet according to the channel identifier therein; then performing sequencing on the data packet according to the packet sequence number;

step 504: judging whether the RTP data packet is abnormal or not according to the status information, and if yes, proceeding to step 506, otherwise executing step 505;

step 505: extracting and forwarding the payload in the RTP data packet to the cache unit 322 via the corresponding HTTP link, and returning to step 501;

step 506: closing the corresponding HTTP link to the cache unit 322;

step 507: judging whether the RTP data packet is the “first packet” or not, and if yes, executing step 508, otherwise proceeding to step 509;

step 508: establishing a new HTTP link to the cache unit 322, and executing step 505;

step 509: discarding the RTP data packet, and proceeding to step 501, and establishing a new HTTP link until a RTP data packet identified with the “first packet” is received again.

The above description takes what is used by the live broadcast encoder being the HTTP signaling and the predetermined conversion format being the RTP format as an example to illustrate the apparatus in accordance with the embodiment of the present invention, and the embodiment of the present invention is also applicable to a live broadcast encoder using the FTP signaling and live broadcast streaming data packets which are converted into other formats, and its implementation process is similar and is not repeated here.

Next, in conjunction with FIG. 6, the method in accordance with the embodiment of the present invention will be described in detail.

As shown in FIG. 6, FIG. 6 is a schematic diagram of the process of the method in accordance with the embodiment of the present invention, mainly comprising:

step 601: the film library server converts the signaling sent by the live broadcast encoder for uploading/deleting/updating a file into live broadcast streaming data packets in a predetermined format; wherein the live broadcast streaming data packet in the predetermined format needs to comprise the following information:

a channel identifier, since the encoder may simultaneously upload/update a media file through a plurality of HTTP/FTP channels, the channel identifier is used to identify different HTTP/FTP channels used by the encoder;

a packet sequence number, which is used to judge whether there are situations such as the packet loss or disordering and so on; data packets with different channel identifiers can use their own independent sequence number space;

status information, such as the offset position of the data packet in the original signaling packets, or the status information that the data packet belongs to the first packet, the last packet or an intermediate packet of the original signaling packets and so on;

alternatively, it may also comprise the transport information, such as the transport protocol (HTTP/FTP), the transport port number and so on, used by the original signaling.

Step 602: the converted live broadcast streaming data packets are actively pushed or passively sent to the intermediate node server, or the intermediate node server receives or actively pulls the live broadcast streaming data packets from the film library server; until the live broadcast streaming data are actively pushed or passively sent to the edge node server; wherein the step of converting the signaling into a live broadcast stream in the predetermined format specifically may comprise: after receiving a signaling sent by the live broadcast encoder for uploading/deleting/updating a file, the film library server judging whether the signaling is complete or not, if yes, converting the signaling into live broadcast streaming data packets in the predetermined format; if no, judging whether the length of data of the received signaling meets the predetermined threshold or not, and converting the data whose length meets the predetermined threshold into live broadcast streaming data packets in the predetermined format; continuing to receive data of the signaling if the length of data of the received signaling is less than the predetermined threshold, performing conversion until its length meets the predetermined threshold or the signaling is complete; and performing conversion compulsorily on data which are still incomplete or whose length has not reached the predetermined threshold yet after exceeding the predetermined timeout period.

Step 603: the edge node server which receives the live broadcast streaming data packets recovers the data packets to the signaling previously sent by the live broadcast encoder, and generates/deletes/updates the corresponding media segment file and the playlist description file according to the instruction of the signaling; wherein the step of recovering the data packets to the signaling previously sent by the live broadcast encoder specifically may comprise: after the edge node server receives the live broadcast streaming data packets, firstly grouping the data packets according to the channel identifiers therein; then performing sequencing on the data packets according to the packet sequence numbers; for each data packet, judging whether the data packet is abnormal or not (whether there is packet loss, check the status information, etc.), and if there is no abnormality, then extracting and recovering the payload therein to the signaling form previously sent by the live broadcast stream server; if there is an abnormality, then discarding the data packet.

When there is a user terminal requesting for live service, the edge node server reads and returns the corresponding media segment file and the playlist description file to the user terminal according to the request.

Since the specific implementation process in accordance with the method embodiment of the present invention has been described in detail in the abovementioned system, it is not repeated here.

In summary, the embodiment of the present invention provides a system and method for distributing live broadcast content, and the technical solution in accordance with the embodiment of the present invention may be used to timely distribute the HTTP live broadcast content generated by the live broadcast encoder to the edge node server, to provide the user terminal in the neighborhood with the HTTP live broadcast service, so as to reduce the response delay of the user requesting service and reduce the delay misalignment between the content viewed by the user and the traditional real-time live broadcast content, thereby improving the user's watching experience. Moreover, for the intermediate non-edge node servers, only simple content distribution and stream forwarding are needed, and there is no need to cache any files, which can greatly reduce the occupancy of the server's resources. In addition, for the film library server and the intermediate node server, there is no need to deploy a cache unit and a storage device, that is, the media segmentation file and the playlist description file are not cached, thereby achieving the purpose of reducing the resource consumption.

The above description is only preferred embodiments of the present invention and not intended to limit the protection scope of the present invention.

### INDUSTRIAL APPLICABILITY

The embodiment of the present invention provides a system and a method for distributing live broadcast content, wherein a film library server converts a signaling sent by a live broadcast encoder for uploading/deleting/updating a file into live broadcast streaming data packets in a predetermined format; it actively pushes or passively sends the converted live broadcast streaming data packets to an intermediate node server, or the intermediate node server receives or actively pulls the live broadcast streaming data packets from the film library server until the live broadcast streaming data are actively pushed or passively sent to an edge node server; and the edge node server which receives the live broadcast streaming data packets recovers the live broadcast streaming data packets to the signaling previously sent by the live broadcast encoder, and generates/deletes/updates a corresponding media segment file and a playlist description file according to an instruction of the signaling; the embodiment of the present invention can reduce a response delay of the user requesting service and decrease a delay misalignment between content viewed by the user and the conventional live broadcast content.

1. A system for distributing live broadcast content, comprising: a film library server, an intermediate node server and an edge node server, wherein
the film library server is configured to convert a signaling sent by a live broadcast encoder for uploading/deleting/updating a file into live broadcast streaming data packets in a predetermined format, and actively push or passively send the live broadcast streaming data packets to the intermediate node server;
the intermediate node server is configured to actively pull the live broadcast streaming data packets from the film library server or receive the live broadcast streaming data packets actively pushed by the film library server, and actively push or passively send the live broadcast streaming data packets to the edge node server;
the edge node server is configured to actively pull the live broadcast streaming data packets from the intermediate node server or receive the live broadcast streaming data packets actively pushed by the intermediate node server, and recover the live broadcast streaming data packets to the signaling previously sent by the live broadcast encoder, as well as generate/delete/update a corresponding media segment file and playlist description file according to an instruction of the signaling.

2. The system of claim 1, wherein the film library server comprises at least: a live broadcast encoder, a signaling conversion unit and a content distribution unit, wherein
the live broadcast encoder is configured to send a signaling for uploading/deleting/updating a file;
the signaling conversion unit is configured to: after receiving the signaling sent by the live broadcast encoder for uploading/deleting/updating a file, determine whether the signaling is complete or not, and if yes, convert the signaling into live broadcast streaming data packets in a predetermined format, and trigger the content distribution unit; if no, determine whether the length of data of the received signaling meets a predetermined threshold or not, and convert data whose length meets the predetermined threshold into live broadcast streaming data packets in the predetermined format; if the length of data of the received signaling is less than the predetermined threshold, continue to receive data of the signaling, and perform conversion until the length meets the predetermined threshold or the signaling is complete; and perform conversion compulsorily on data which is still incomplete or whose length has not reached the predetermined threshold yet after exceeding a predetermined timeout period; and trigger the content distribution unit after conversion;
the content distribution unit is configured to actively push the live broadcast streaming data packets to the intermediate node server; or forward the live broadcast streaming data packets to the intermediate node server when there is a request from the intermediate node server.

3. The system of claim 1, wherein the edge node server comprises at least: a signaling recovery unit, a cache unit and a storage device, wherein
the signaling recovery unit is configured to: after receiving the live broadcast streaming data packets, recover the live broadcast streaming data packets to a signaling form previously sent by the live broadcast streaming server, and determine whether the recovered data packets are abnormal or not, and if yes, discard the data packets; if no, extract and send payloads therein to the cache unit;
the cache unit is configured to put together payloads obtained through several times into a complete signaling, and trigger the storage device to generate/delete/update a corresponding media segment file and playlist description file according to an instruction of the signaling;
the storage device is configured to store the media segment file and the playlist description file.

4. The system of claim 3, wherein the edge node server further comprises:
a content service unit, which is configured to: when there is a user terminal requesting for live broadcast service, read and return the corresponding media segment file and playlist description file to the user terminal according to the request.

5. The system of claim 3, wherein the live broadcast streaming data packet comprises at least: a packet sequence number, a channel identifier and status information whether a data packet is complete or not, and the signaling recovery unit is configured to: after receiving the live broadcast streaming data packets, perform grouping according to the channel identifiers therein; then perform sequencing on the data packets according to the packet sequence numbers; for each data packet, determine whether the data packet is abnormal or not according to the status information, if no, extract and send a payload therein to the cache unit, otherwise, discard the data packet.

6. The system of claim 1, wherein the signaling sent by the live broadcast encoder is a HTTP signaling or FTP signaling, and the predetermined format is a RTP format.

7. A method for distributing live broadcast content, comprising:
a film library server converting a signaling sent by a live broadcast encoder for uploading/deleting/updating a file into live broadcast streaming data packets in a predetermined format;
actively pushing or passively sending the converted live broadcast streaming data packets to an intermediate node server, or, the intermediate node server receiving or actively pulling the live broadcast streaming data packets from the film library server; until the live broadcast streaming data packets are actively pushed or passively sent to an edge node server;
the edge node server which receives the live broadcast streaming data packets recovering the live broadcast streaming data packets to the signaling previously sent by the live broadcast encoder, and generating/deleting/updating a corresponding media segment file and playlist description file according to an instruction of the signaling.

8. The method of claim 7, wherein the method further comprises:
when there is a user terminal requesting for live broadcast service, the edge node server reads and returns the corresponding media segment file and playlist description file to the user terminal according to the request.

9. The method of claim 7, wherein the step of converting the signaling into a live broadcast stream in a predetermined format comprises:
after receiving the signaling sent by the live broadcast encoder for uploading/deleting/updating a file, the film library server determining whether the signaling is complete or not, if yes, converting the signaling into live broadcast streaming data packets in the predetermined format; if no, determining whether the length of data of the received signaling meets a predetermined threshold or not, and converting data whose length meets the predetermined threshold into live broadcast streaming data packets in the predetermined format; continuing to receive data of the signaling if the length of data of the received signaling is less than the predetermined threshold, and performing conversion until the length meets the predetermined threshold or the signaling is complete.

10. The method of claim 9, wherein the method further comprises:
performing conversion compulsorily on data which is still incomplete or whose length has not reached the predetermined threshold yet after exceeding a predetermined timeout period.

11. The method of claim 7, wherein the live broadcast streaming data packet comprises at least: a packet sequence number, a channel identifier, and status information whether a data packet is complete or not, then the step of recovering the data packets to the signaling previously sent by the live broadcast encoder comprises:
after receiving the live broadcast streaming data packets, firstly, the edge node server performing grouping according to the channel identifiers therein; then performing sequencing on the data packets according to the packet sequence numbers; for each data packet, determining whether the data packet is abnormal or not according to the status information, and if no, extracting and recovering a payload therein to a signaling form previously sent by a live broadcast streaming server, otherwise, discarding the data packet.

12. The system of claim 2, wherein the edge node server comprises at least: a signaling recovery unit, a cache unit and a storage device, wherein
the signaling recovery unit is configured to: after receiving the live broadcast streaming data packets, recover the live broadcast streaming data packets to a signaling form previously sent by the live broadcast streaming server, and determine whether the recovered data packets are abnormal or not, and if yes, discard the data packets; if no, extract and send payloads therein to the cache unit;
the cache unit is configured to put together payloads obtained through several times into a complete signaling, and trigger the storage device to generate/delete/update a corresponding media segment file and playlist description file according to an instruction of the signaling;
the storage device is configured to store the media segment file and the playlist description file.

13. The system of claim 12, wherein the edge node server further comprises:
a content service unit, which is configured to: when there is a user terminal requesting for live broadcast service, read and return the corresponding media segment file and playlist description file to the user terminal according to the request.

14. The system of claim 12, wherein the live broadcast streaming data packet comprises at least: a packet sequence number, a channel identifier and status information whether a data packet is complete or not, and the signaling recovery unit is configured to: after receiving the live broadcast streaming data packets, perform grouping according to the channel identifiers therein; then perform sequencing on the data packets according to the packet sequence numbers; for each data packet, determine whether the data packet is abnormal or not according to the status information, if no, extract and send a payload therein to the cache unit, otherwise, discard the data packet.

15. The system of claim 2, wherein the signaling sent by the live broadcast encoder is a HTTP signaling or FTP signaling, and the predetermined format is a RTP format.

16. The method of claim 8, wherein the step of converting the signaling into a live broadcast stream in a predetermined format comprises:
after receiving the signaling sent by the live broadcast encoder for uploading/deleting/updating a file, the film library server determining whether the signaling is complete or not, if yes, converting the signaling into live broadcast streaming data packets in the predetermined format; if no, determining whether the length of data of the received signaling meets a predetermined threshold or not, and converting data whose length meets the predetermined threshold into live broadcast streaming data packets in the predetermined format; continuing to receive data of the signaling if the length of data of the received signaling is less than the predetermined threshold, and performing conversion until the length meets the predetermined threshold or the signaling is complete.

17. The method of claim 16, wherein the method further comprises:
performing conversion compulsorily on data which is still incomplete or whose length has not reached the predetermined threshold yet after exceeding a predetermined timeout period.

18. The method of claim 8, wherein the live broadcast streaming data packet comprises at least: a packet sequence number, a channel identifier, and status information whether a data packet is complete or not, then the step of recovering the data packets to the signaling previously sent by the live broadcast encoder comprises:
after receiving the live broadcast streaming data packets, firstly, the edge node server performing grouping according to the channel identifiers therein;
then performing sequencing on the data packets according to the packet sequence numbers; for each data packet, determining whether the data packet is abnormal or not according to the status information, and if no, extracting and recovering a payload therein to a signaling form previously sent by a live broadcast streaming server, otherwise, discarding the data packet.
